(19) United States
(12) Patent Application Publication
(10) Pub. No.: US 2009/0245350 A1
(43) Pub. Date: Oct. 1, 2009

(54) IMAGE CODING APPARATUS AND IMAGE CODING METHOD

(75) Inventors: Yuki Maruyama, Osaka (JP); Hiroshi Arakawa, Nara (JP); Hideyuki Ohgose, Osaka (JP); Takahiro Nishi, Nara (JP)

Correspondence Address: WENDEROTH, LIND & PONACK L.L.P., 1030 15th Street, N.W., Suite 400 East, Washington, DC, 20005-1503, US

(73) Assignee: PANASONIC CORPORATION, Osaka (JP)

(21) Appl. No.: 12/301,528

(22) PCT Filed: Jun. 14, 2007
(86) PCT No.: PCT/JP2007/061995

§ 371 Date: Nov. 19, 2008

(30) Foreign Application Priority Data
Jun. 21, 2006 (JP) 2006-171810

(51) Int. Cl. H04N 7/26; H04N 11/04

(52) U.S. Cl. 375/240.03; 375/240.24; 375/240.13; 375/E07.126

(57) ABSTRACT

To provide an image coding apparatus and an image coding method for reliably suppressing delays in image coding processing while suppressing increases in circuit size. An image coding apparatus (100) includes: an image coding unit (101) which generates a coded picture by sequentially coding a plurality of input pictures; a skipped picture generation unit (104) which generates a skipped picture; an entropy coding unit (102) which performs entropy coding on the coded picture and the skipped picture; and a coding control unit (103) which determines whether or not entropy coding has generated a coded picture including a macroblock having a code amount exceeding a threshold value, and which causes the skipped picture generation unit (104) to generate a skipped picture based on a specific picture that is one of the plurality of input pictures that corresponds to the coded picture, without causing the image coding unit (101) to perform coding.

### TECHNICAL FIELD

The present invention relates to an image coding apparatus and an image coding method for compression-coding images and recording the compression-coded images onto a storage medium, such as an optical disk, a magnetic disk, a flash memory or the like, and relates in particular to an image coding apparatus and an image coding method for coding in accordance with H.264 coding scheme.

### BACKGROUND ART

Data compression techniques are currently developing and used for digital video data for the purpose of processing the amount of data increasing with the development of digital video technology. The development is embodied as compression technology specific to video data, which utilizes characteristics of the video data. In addition, sophisticated operations in compression technology have become possible due to improved processing capabilities of computers and other information processing apparatuses, and thereby the compression rate for the video data is significantly improving. For example, the compression technique used for satellite and digital terrestrial Hi-vision broadcasting is a coding scheme referred to as MPEG2, and the video data is compressed to about one thirtieth in the satellite digital Hi-vision broadcasting.

It is said that AVC/H.264, which has become standardized as the next video compression technology after MPEG2, embodies a two-fold compression rate compared to MPEG2. In AVC/H.264, high compression rates are embodied by implementing and combining a number of compression techniques, and thereby the operation amount is significantly increasing.

One of the compression technology implemented in AVC/H.264 is entropy coding (variable length coding). For the method of entropy coding, two methods are provided: CAVLC and CABAC. CAVLC stands for Context-based Adaptive Variable Length Coding and is a method of coding, in coding a DCT coefficient, the run that is a length of successive 0s and the level by using a variable length coding table, starting from the direction opposite to the direction of scanning.

CABAC stands for Context-based Adaptive Binary Arithmetic Coding and is a method of changing the appearance frequency of a coding target which varies with time; CABAC is generally referred to as arithmetic coding. In CABAC, in addition to ordinary arithmetic coding, contexts are assigned to respective codes to be compressed, and the appearance frequency is changed according to each of the contexts.

In CABAC, coding is mainly divided into two processes: one is referred to as binarization and is for converting, into binary data, multivalue information to be coded that is referred to as syntax, and the other is for performing arithmetic coding by calculating a context with respect to the binary data converted by the binarization.

In addition, in CABAC coding, some contexts require outputting of a large amount of bitstreams, thereby necessitating operations at high clock frequencies and causing circuit size and power consumption to be increased. Thus, in CABAC, it is possible to suppress clock frequencies, through utilization of a characteristic that the processing amount significantly varies according to the image data to be coded, by implementing the circuit with an average processing amount for CABAC, providing a binarized data buffer which absorbs increase and decrease of the processing amount, and causing a circuit for binarization and a circuit for arithmetic coding to operate asynchronously.

Meanwhile, in AVC/H.264, the maximum code amount per macroblock is limited to 3200 bits in the case of 4-2-0 format, bit-depth8 bit.

In arithmetic coding, however, it is difficult to know a precise amount of codes to be outputted in CABAC before coding since the coding for obtaining appearance probability for 0 and 1 is performed with respect to each bit in the binary data, and the appearance probability is adoptively switched bit by bit and updated according to each bit value. Therefore, when the code amount exceeds 3200 bits as a result of coding the macroblock, coding should be performed again by changing the coding condition for the macroblock. That is, whether or not the limit for the maximum code amount for the macroblock is satisfied is judged after CABAC coding

As a result, in some cases, a macroblock having over 3200 bits is detected with several frames of binary data being stored in the binarized data buffer due to a delay caused by the arithmetic coding performed at an average processing speed. If this is the case, in order to perform a second coding, it is necessary to discard all such several frames of binarized data stored in the binarized data buffer, and then to perform coding again starting from the frame (or the macroblock) having over 3200 bits. As a result, the delay in image coding processing is further increased.

Thus, an image coding apparatus is suggested which monitors the data to be inputted in the arithmetic coding unit, and switches to I_PCM coding when the code amount is nearly exceeding 3200 bits (for example, see Patent-Reference 1). That is, the image coding apparatus intends to perform CABAC coding on an input picture that is not coded without performing a second coding on a picture that has a macroblock having a code amount nearly exceeding 3200 bits, by estimating the code amount after arithmetic coding before the arithmetic coding is actually performed.

### Patent Reference 1: Japanese Unexamined Patent Application Publication No. 2004-135251

### DISCLOSURE OF INVENTION

### Problems that Invention is to Solve

However, the image coding apparatus disclosed in the above Patent-Reference 1 has a problem of delays occurring in image coding processing as well as increases in circuit size.

In other words, the image coding apparatus of the above Patent Reference 1 is not capable of estimating an accurate code amount after arithmetic coding and cannot therefore prevent the generation of a macroblock having over 3200 bits. When the macroblock having over 3200 bits is generated, it is necessary to perform a second coding by discarding all the data included in the binarized data buffer and reading all the data succeeding the picture violating the standard. This causes a delay in the image coding processing performed on the input picture, causing a number of input pictures to be stored in the memory and thereby increasing the circuit size.

Thus, the present invention is conceived in view of such a problem, and it is an object of the present invention to provide an image coding apparatus and an image coding method for reliably suppressing delays in image coding processing as well as suppressing increases in the circuit size.

### Means to Solve the Problems

To achieve the above object, the image coding apparatus according to the present invention is an image coding apparatus that includes: an image coding unit which generates a coded picture having a pixel value by sequentially coding a plurality of input pictures; a skipped picture generation unit which generates a skipped picture not having a pixel value; an entropy coding unit which performs entropy coding on the coded picture and the skipped picture; and a coding control unit which includes a determination unit that determines whether or not the entropy coding by the entropy coding unit has generated a coded picture including a macroblock having a code amount exceeding a threshold value, and which causes the skipped picture generation unit to generate a skipped picture for a specific picture without causing the image coding unit to perform coding, the specific picture being one of pictures that are an input picture corresponding to the coded picture including the macroblock and respective input pictures succeeding the input picture in a coding order. For example, the determination unit uses the maximum code amount per macroblock specified by AVC/H.264 as the threshold value. In addition, the entropy coding unit performs the entropy coding in accordance with Context-based Adaptive Binary Arithmetic Coding (CABAC).

Conventionally, when a coded picture including a macroblock exceeding the threshold value is generated, that is, when a standard violation occurs, coding processing such as prediction coding is performed on every input picture succeeding the input picture violating the standard, whereas in the present invention, a skipped picture not having a pixel value is generated for the specific picture without performing coding processing such as prediction coding. Here, the time required for the prediction coding for the specific picture is much longer than the time for generating the skipped picture, thereby making it possible to save time for the coding and reliably suppress the delay in the image coding processing performed on the input picture. As a result, it is possible to suppress the increase in circuit size by suppressing the capacity of the memory for holding the input pictures, and further to achieve reduction of power consumption.

In addition, the image coding unit may perform coding using a quantization step value, and the coding control unit may cause the image coding unit to perform a second coding on the input picture using a quantization step value larger than the quantization step value that has been used in the coding previously performed, when the input picture corresponding to the coded picture including the macroblock is not the specific picture. Alternatively, the coding control unit may cause the image coding unit to generate a new coded picture from the input picture, when the input picture corresponding to the coded picture including the macroblock is not the specific picture.

With this, it is possible to reliably suppress the code amount for the macroblocks included in the coded picture below the threshold value when entropy coding is performed on the coded picture generated by the second coding.

In addition, the coding control unit may use a bottom field as the specific picture, from among the pictures that are the input picture corresponding to the coded picture including the macroblock and the respective input pictures succeeding the input picture in the coding order. Here, the skipped picture generation unit may generate the skipped picture in which a macroblock on a top-left edge indicates that motion compensation should be performed by 0 pixel horizontally and 0.5 pixel vertically with reference to a top field located immediately preceding the skipped picture in the coding order, and in which other macroblocks are skipped macroblocks.

With this, an image decoding apparatus, having obtained a stream generated by the entropy coding, can decode the skipped picture into a picture approximate to the bottom field before the coding by performing, based on the skipped picture for the bottom field, motion compensation by 0.5 pixel vertically with reference to a top field located immediately preceding the skipped picture in every macroblock.

In addition, the coding control unit may use a top field as the specific picture, from among the pictures that are the input picture corresponding to the coded picture including the macroblock and the respective input pictures succeeding the input picture in the coding order. Here, the skipped picture generation unit may generate the skipped picture in which a macroblock on a top-left edge indicates that motion compensation should be performed by 0 pixel vertically and − (minus) 0.5 pixel horizontally with reference to a bottom field located immediately preceding the skipped picture in the coding order, and in which other macroblocks are skipped macroblocks.

With this, the image decoding apparatus, having obtained a stream generated by the entropy coding, can decode the skipped picture into a picture approximate to the top field before the coding by performing, based on the skipped picture for the top field, motion compensation by −0.5 pixel vertically with reference to the bottom field located immediately preceding the skipped picture in every macroblock.

Note that the present invention can be implemented not only as such an image coding apparatus but also as an image coding method which includes, as steps, characteristic units included in such an image coding apparatus, and also as a program which causes a computer to execute these steps. Furthermore, it goes without saying that such a program can be distributed through the recording media such as CD-ROMs and the transmission media such as the Internet.

### EFFECTS OF THE INVENTION

The image coding apparatus of the present invention can reliably suppress delays in the image coding as well as suppressing increases in the circuit size, thereby allowing reduction of power consumption. Therefore, the practical value of the present invention is significantly high today when video cameras, camera-equipped cellular phones, and so on are becoming widely popularized.

### BRIEF DESCRIPTION OF DRAWINGS

FIG. 1 is a block diagram showing a configuration of an image coding apparatus in an embodiment of the present invention.

FIG. 2A is a diagram showing a configuration of a skipped picture in the embodiment of the present invention.

FIG. 2B is a diagram showing a configuration of the skipped picture in the embodiment of the present invention.

FIG. 3 is a block diagram showing a configuration of an image coding unit in the embodiment of the present invention.

FIG. 4 is a block diagram showing a configuration of an entropy coding unit in the embodiment of the present invention.

FIG. 5 is an explanatory diagram for describing the operation of the image coding apparatus in the embodiment of the present invention.

FIG. 6 is a flowchart showing an operation of a coding control unit in the embodiment of the present invention.

FIG. 7 is a flowchart showing an operation of a coding control unit according to modification 1 of the embodiment of the present invention.

FIG. 8 is an explanatory diagram for describing an operation of an image coding apparatus according to modification 2 of the embodiment of the present invention.

FIG. 9 is a flowchart showing an operation of a coding control unit according to modification 2 of the embodiment of the present invention.

FIG. 10 is an explanatory diagram for describing an operation of an image coding apparatus according to modification 3 of the embodiment of the present invention.

FIG. 11 is a flowchart showing an operation of a coding control unit according to modification 3 of the embodiment of the present invention.

FIG. 12 is a flowchart showing an operation of a coding control unit according to modification 4 of the embodiment of the present invention.

### NUMERICAL REFERENCES

100 Image coding apparatus
101 Image coding unit
102 Entropy coding unit
103 Coding control unit
104 Skipped picture generation unit
201 Input image data memory
202 Reference image data memory
203 Intra prediction unit
204 Motion vector detection unit
205 Motion compensation unit
206 Switch
207 Difference operation unit
208 Orthogonal transform unit
209 Quantization unit
201 Inverse quantization unit
202 Inverse orthogonal transform unit
212 Addition unit

### BEST MODE FOR CARRYING OUT THE INVENTION

Hereinafter, an image coding apparatus according to an embodiment of the present invention shall be described with reference to the drawings.

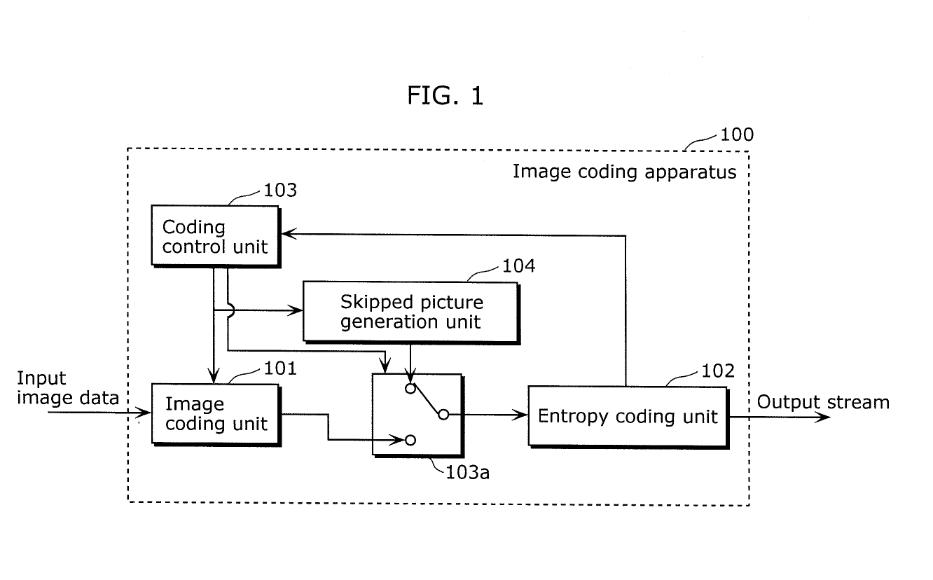

FIG. 1 is a block diagram showing a configuration of an image coding apparatus in an embodiment of the present invention.

An image coding apparatus 100 includes: an image coding unit 101, an entropy coding unit 102, a coding control unit 103, a skipped picture generation unit 104, and a switch 103a.

The image coding unit 101 obtains input image data and sequentially performs prediction coding (intra-prediction coding or inter-prediction coding) on respective input pictures included in the input image data. As a result, the image coding unit 101 generates a prediction-coded picture having a pixel value.

The skipped picture generation unit 104 generates a skipped picture not having a pixel value. An image decoding apparatus, having obtained such a bitstream including a skipped picture as this, utilizes the decoding result of another picture for the skipped picture. In other words, the image decoding apparatus, upon judging that the picture to be decoded is a skipped picture, decodes the skipped picture into a picture having the same pixel value as the other picture that has already been decoded.

Upon obtaining the prediction-coded picture generated by the image coding unit 101, the entropy coding unit 102 performs entropy coding (variable length coding) on the prediction-coded picture, and outputs an output stream (bitstream) indicating the result. In addition, upon obtaining the skipped picture generated by the skipped picture generation unit 104, the entropy coding unit 102 performs entropy coding on the skipped picture, and outputs an output stream indicating the result.

The switch 103a connects, by switching, the entropy coding unit 102 to one of the image coding unit 101 and the skipped picture generation unit 104 according to the instruction from the coding control unit 103.

The coding control unit 103 sets a coding mode by switching between a prediction-coding mode and a skip-coding mode according to the code amount generated by entropy coding.

The prediction-coding mode is an ordinary setting mode, in which prediction coding and entropy coding are performed on respective input pictures included in the input image data. When this prediction-coding mode is set, the coding control unit 103 controls the switch 103a so that the entropy coding unit 102 is constantly connected to the image coding unit 101.

The skip-coding mode is a mode in which a skipped picture is generated for an input picture of a predetermined type (specific picture) included in the input image data without prediction coding being performed, and entropy coding is performed on the skipped picture. In addition, in the skip-coding mode, as with the above-described prediction-coding mode, prediction coding and entropy coding are performed on respective pictures included in the input image data except for the specific picture. When this skip-coding mode is set, the coding control unit 103 controls the switch 103a so that the entropy coding unit 102 is connected to the skipped picture generation unit 104 for the specific picture, and that the entropy coding unit 102 is connected to the image coding unit 101 for the other input pictures.

Here, in the present embodiment, a bottom field is assumed as the specific picture.

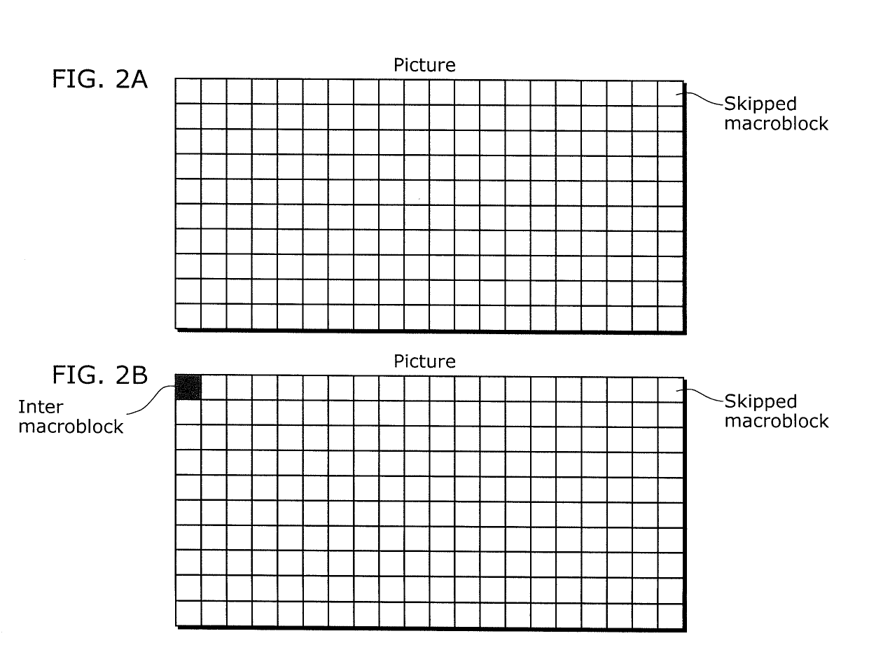

FIGS. 2A and 2B are diagrams showing the structure of the skipped picture in the present embodiment.

As FIG. 2A shows, for example, the skipped picture generation unit 104 generates a skipped picture made up of macroblocks that are all skipped macroblocks.

The image decoding apparatus, having obtained such a skipped picture as a bottom field that is the specific picture, decodes the skipped picture into a bottom field having the same picture as a top field located immediately preceding the bottom field in the coding order with reference to the top field. As a result, the decoded skipped picture has an image approximate to the bottom field before the coding.

In addition, the skipped picture generation unit 104 may also generate, as FIG. 2B shows, for example, a skipped picture in which only a macroblock on the top left edge is an inter macroblock and the other macroblocks are skipped macroblocks. The inter macroblock indicates a top field located immediately preceding the skipped picture in the coding order as the picture to be referred to (reference picture) and has information indicating that motion compensation should be performed by 0 pixel horizontally and 0.5 pixel vertically with reference to the top field.

The image decoding apparatus, having obtained such a skipped picture as the bottom field that is the specific picture, can decode the skipped picture into a picture more approximate to the bottom field before the coding by performing motion compensation by 0.5 pixel vertically with reference to a top field located immediately preceding the skipped picture in every macroblock.

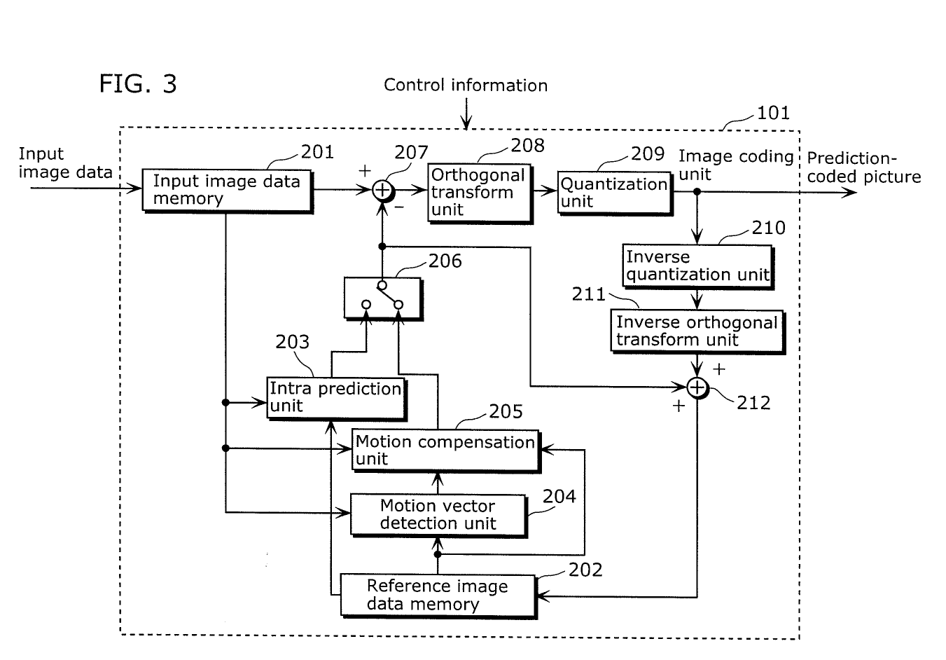

FIG. 3 is a block diagram showing the configuration of the image coding unit 101.

The image coding unit 101 includes: an input image data memory 201, a reference image data memory 202, an intra prediction unit 203, a motion vector detection unit 204, a motion compensation unit 205, a switch 206, a difference operation unit 207, an orthogonal transform unit 208, a quantization unit 209, an inverse quantization unit 210, an inverse orthogonal transform unit 211, and an addition unit 212.

The input image data memory 201 obtains and stores input image data. The reference image data memory 202 stores, as a reference picture, a picture obtained by performing prediction coding on an input picture included in the input image data and further decoding the prediction-coded input picture. Note that the data stored in the input image data memory 201 and the reference image data memory 202 are used for a second prediction coding when a standard violation where the code amount per macroblock exceeds 3200 bits occurs at the entropy coding unit 102.

The intra prediction unit 203 generates a prediction image by performing, on a per-image-area basis, intra prediction on an input picture included in the input image data. At this time, the intra prediction unit 203 uses a pixel value stored in the reference image data memory 202. The pixel value is a pixel value for the image area that is included in the input picture to be intra-prediction coded and has already been prediction-coded and decoded.

The motion vector detection unit 204: searches for a reference picture stored in the reference image data memory 202; detects an image area most approximate to the input picture so as to determine a motion vector indicating the position of the detected image area; and determines the size of a block to be coded that has a least margin of error as well as determining a motion vector in the determined size.

The motion compensation unit 205 generates a prediction image by taking the pixel value of the image area indicated by the motion vector detected by the motion vector detection unit 204 out of the reference picture stored in the reference image data memory 202.

The switch 206 connects the intra prediction unit 203 to the difference operation unit 207 when intra-prediction coding is performed on the input picture, and connects the motion compensation unit 205 to the difference operation unit 207 when inter-prediction coding is performed on the input picture.

The difference operation unit 207, having obtained the input picture from the input image data memory 201, calculates a difference value between the input picture and the prediction image, and outputs the difference value to the orthogonal transform unit 208.

The orthogonal transform unit 208 converts the difference value into a frequency coefficient, and outputs the frequency coefficient to the quantization unit 209.

The quantization unit 209 quantizes the frequency coefficient outputted from the orthogonal transform unit 208 using a predetermined quantization step value, and outputs the resultant quantized value to the switch 103a. In other words, the image coding unit 101 outputs the prediction-coded picture to the switch 103a.

The inverse quantization unit 210 restores, through inverse quantization, the quantized value outputted from the quantization unit 209 into a frequency coefficient, and outputs the frequency coefficient to the inverse orthogonal transform unit 211.

The inverse orthogonal transform unit 211 converts, through inverse frequency conversion, the frequency coefficient outputted from the inverse quantization unit 210 into a pixel difference value, and outputs the pixel difference value to the addition unit 212.

The addition unit 212 generates a reference picture by adding the pixel difference value outputted from the inverse conversion unit 211 to the prediction image outputted from the intra prediction unit 203 or the motion compensation unit 205, and stores the reference picture in the reference image data memory 202.

In addition, control information is information that is outputted from the coding control unit 103 and is for controlling the image coding unit 101. The image coding unit 101 can change, for example, the quantization step value or change the macroblock into I_PCM according to the control information.

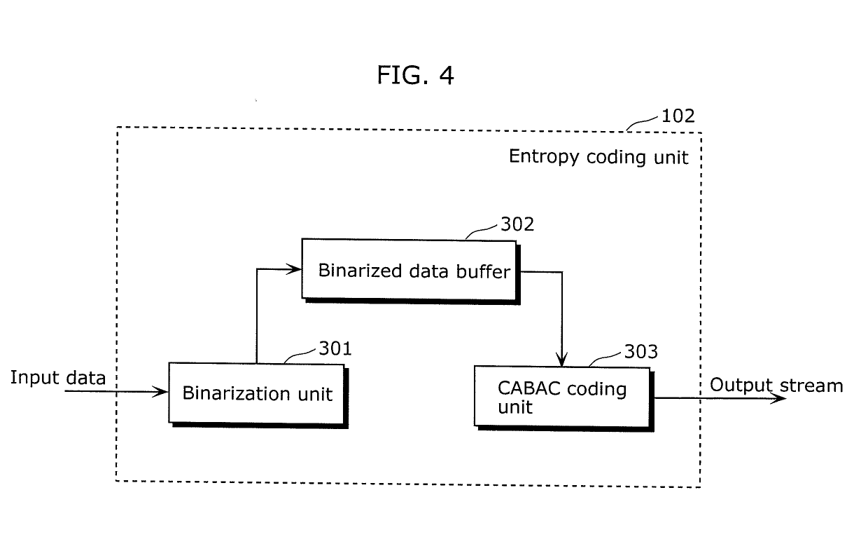

FIG. 4 is a block diagram showing the configuration of the entropy coding unit 102.

The entropy coding unit 102 includes: a binarization unit 301, a binarized data buffer 302, and a CABAC coding unit 303.

Upon obtaining a prediction-coded picture or a skipped picture as input data, for example, with respect to each macroblock, the binarization unit 301 converts multivalue information indicated by the macroblock into binary data, and stores the binary data in the binarized data buffer 302.

The CABAC coding unit 303 obtains the binary data stored in the binarized data buffer 302 and performs arithmetic coding on the binary data by calculating the context. Note that the processing by CABAC coding unit 303 is performed asynchronously with the processing of the binarization unit 301.

When the code amount per macroblock, as a result of the arithmetic coding, does not exceed 3200 bits for every macroblock included in the prediction-coded picture, the CABAC coding picture 303 outputs an output stream indicating the result of the arithmetic coding performed on the prediction-coded picture. At this time, in each outputting of such an output stream, the coding control unit 103 causes the image coding unit 101 to delete unnecessary data for the second prediction coding that is stored in the input image data memory 201 and the reference image data memory 202 of the image coding unit 101.

In addition, when the code amount per macroblock exceeds 3200 bits for any one of the macroblocks included in the prediction-coded picture as a result of the arithmetic coding, the CABAC coding unit 303 does not output an output stream indicating the result of the arithmetic coding performed on the prediction-coded picture. Then, the CABAC coding unit 303 deletes binary data already stored in the binarized data buffer 302.

The processing by the coding control unit 103 in the above-described present embodiment shall be described in detail.

The coding control unit 103 determines whether or not entropy coding by the entropy coding unit 102 has generated over 3200 bits in each macroblock included in the prediction-coded picture, that is, determines whether or not the standard violation has occurred. That is, in the present embodiment, the coding control unit 103 includes a determination unit. Then, upon determining that the standard violation has occurred, the coding control unit 103 switches the prediction-coding mode to the skip-coding mode. Here, an input picture corresponding to the prediction-coded picture including a macroblock violating the standard is hereinafter referred to as a violating input picture.

When switched to the skip-coding mode, the coding control unit 103 performs the processing by the skip-coding mode on the violating input picture and respective input pictures succeeding the violating input picture in the decoding order from among the respective pictures included in the input image data. Here, when the violating picture is not the specific picture described above, the coding control unit 103 performs prediction coding on the violating input picture again through control of the image coding unit 101, that is, performs the second prediction coding on the violating input picture. In this second prediction coding, the coding control unit 103 prevents the recurrence of the standard violation by making the quantization step value at the image coding unit 101 larger than the value that has previously been used.

Meanwhile, as the conventional example shows, when prediction coding and entropy coding are performed on all the input pictures succeeding the violating input picture when the standard violation occurs, the second prediction coding is performed on the input picture that has already been converted into the binary data by prediction coding. As a result, with each occurrence of the standard violation, the delay in image coding processing responding to the inputting of input image data is further increased.

Thus, the coding control unit 103 in the present embodiment implements such a skip-coding mode as described above, for example, by continuing the skip-coding mode until an input picture to be coded catches up with an input picture that is to be coded when the standard violation does not occur, and then switching the skip-coding mode to the prediction-coding mode. Here, at the current point in time, the number of pictures between the input picture that is to be coded when the standard violation does not occur and the input picture to be actually decoded is hereinafter referred to as a coding delay count. Accordingly, the above skip-coding mode continues until the coding delay count becomes 0. In addition, the coding control unit 103 in the present embodiment identifies the coding delay count by monitoring an identification number such as a Picture Order Count (POC) for the input picture to be coded by the image coding unit 101.

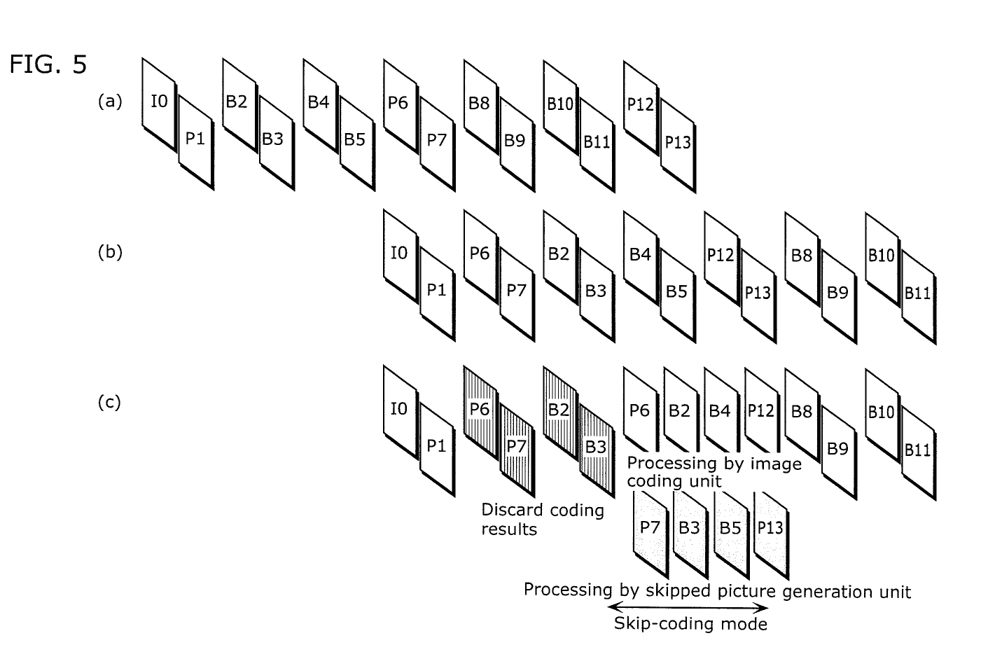

FIG. 5 is an explanatory diagram for describing the operation of the image coding apparatus 100 in the present embodiment.

For example, as FIG. 5(a) shows, each input picture is stored in the input image data memory 201 of the image coding unit 101 in an order starting from picture I0, to picture Pt, to picture B2, to picture B3, . . . . Note that in FIG. 5 the initial alphabet included in the code of each input picture indicates the coding type of the input picture, and the subsequent numeral included in the code indicates where the input picture is located in the display order. For example, picture I0 is an initial (0th) I-picture to be displayed, and picture P1 is a first P-picture to be displayed.

In addition, when the standard violation does not occur, the image coding apparatus 100 performs prediction coding and entropy coding, as FIG. 5(b) shows, on each input picture stored in the input image data memory 201 of the image coding unit 101 in an order staring from picture I0; to picture P1, to picture P6, to picture P7, . . . .

On the other hand, as FIG. 5(c) shows, the image coding apparatus 100 performs the processing by the skip-coding mode when the standard violation occurs. For example, assume that the image coding apparatus 100 determines that entropy coding (arithmetic coding) performed on a macroblock of the picture P6 has resulted in the generation of over 3200 bits for the macroblock. At this time, as a result of the prediction coding and binarization performed on pictures P6, P7, B2, and B3, the image coding apparatus 100 discards all the binary data already stored in the binarized data buffer 302 and performs processing by the skip-coding mode.

That is, the image coding apparatus 100 performs the processing by the skip-coding mode on picture 6 that is a violating input picture and respective input pictures succeeding the picture P6 in the coding order until the coding delay count becomes 0.

Specifically, since picture P6 is not a bottom field that is the specific picture, the coding control unit 103 of the image coding apparatus 100 causes the image coding unit 101 to perform a second prediction coding on the picture P6, and causes the entropy coding unit 102 to perform entropy coding on the result. Then, since the subsequent picture P7 is a bottom field that is the specific picture, the coding control unit 103 causes the skipped picture generation unit 104 to generate a skipped picture for the picture P7, and causes the entropy coding unit 102 to perform entropy coding on the result.

In the same manner as described above, since pictures B2, B4, and P12 are not bottom fields, the coding control unit 103 causes the image coding unit 101 to perform prediction coding on the input pictures, and causes the entropy coding unit 102 to perform entropy coding on the result. In addition, since pictures B3, B5, and P13 are bottom fields, the coding control unit 103 causes the skipped picture generation unit 104 to generate skipped pictures for the input pictures, and causes the entropy coding unit 102 to perform entropy coding on the result.

Upon completion of the processing on picture 13, the coding delay count becomes 0, and thereby the coding control unit 103 sets the coding mode by switching from the skip-coding mode to the prediction-coding mode. As a result, prediction coding is performed on every one of the pictures starting from picture B8 regardless of whether or not the pictures are bottom fields.

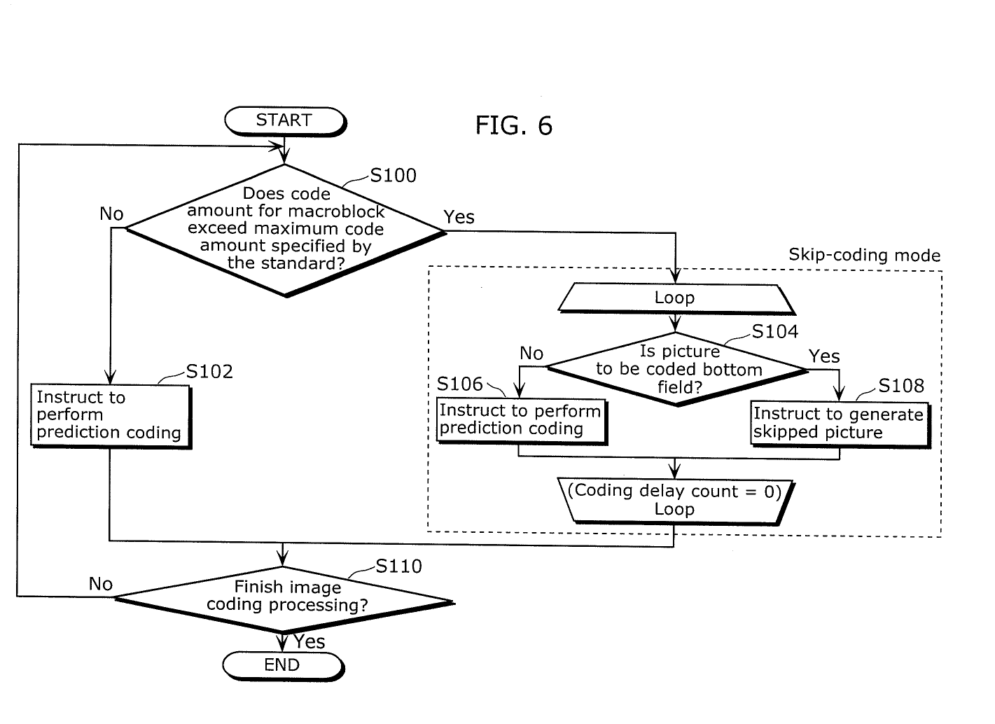

FIG. 6 is a flowchart showing the operation of the coding control unit 103 in the present embodiment.

The coding control unit 103 determines whether or not entropy coding by the entropy coding unit 102 has generated over 3200 bits per macroblock, that is, determines whether or not a prediction-coded picture violating the standard has been generated (Step S100).

Here, upon determining that the standard violation has not occurred (No in Step S100), the coding control unit 103 causes the prediction-coding mode to continue (Step S102). That is, the coding control unit 103 instructs the image coding unit 101 to sequentially perform prediction coding on the input pictures included in the input image data while controlling the switch 103a so that the image coding unit 101 is connected to the entropy coding unit 102.

On the other hand, upon determining that the standard violation has occurred (Yes in Step S100), the coding control unit 103 further determines whether or not the input picture (the picture to be coded) is a bottom field (Step S104). Note that the first picture to be coded at this time is a picture violating the standard. Then, upon determining that the input picture is not a bottom field, that is, upon determining that the input picture is a top field (No in Step S104), the coding control unit 103 instructs the image coding unit 101 to perform prediction coding on the picture to be coded while controlling the switch 103a so that the image coding unit 101 is connected to the entropy coding unit 102 (Step S106).

In addition, upon determining that the input picture is a bottom field in Step S104 (Yes in Step S104), the coding control unit 103 instructs the skipped picture generation unit 104 to generate a skipped picture for the picture to be coded while controlling the switch 103a so that the skipped picture generation unit 104 is connected to the entropy coding unit 102 (Step S108).

Then, the coding control unit 103 continues the processing of steps from S104 to S108, that is, sequentially performs the processing by the skip-coding mode on the input pictures succeeding the violating input picture as the pictures to be coded until the coding delay count becomes 0.

In addition, the coding control unit 103 determines whether or not to finish the image coding processing (Step S110); all the processing operations are finished when it is determined that the processing should be finished (Yes in Step S110), whereas the operations starting from Step S100 are repeatedly performed when it is determined that the processing should not be finished (No in Step S110).

Thus, in the present embodiment, when the standard violation occurs, coding processing such as prediction coding is not performed on all of the input pictures succeeding the input picture violating the standard, and a skipped picture not having a pixel value is generated for the bottom field that is the specific picture without performing any coding such as prediction coding. Here, the time required for the prediction coding for the specific picture is much longer than the time for generating the skipped picture, thereby making it possible to save time for the coding and reliably suppress the delay in the image coding processing performed on the input picture. As a result, it is possible to suppress the increase in circuit size by suppressing the capacity of the input image data memory 201 which holds input memory. Furthermore, this allows reduction of power consumption.

(Modification 1)

The coding control unit 103 according to the present modification uses a top field as the specific picture.

As FIG. 2A shows, for example, the skipped picture generation unit 104 according to the present modification generates a skipped picture made up of macroblocks that are all skipped macroblocks.

The image decoding apparatus, having obtained such a skipped picture as a top field that is the specific picture, refers to a bottom field located immediately preceding the top field in the coding order and decodes the skipped picture into a top field having the same picture as the bottom field. As a result, the decoded skipped picture has an image approximate to the top field before the coding.

In addition, the skipped picture generation unit 104 according to the present modification may also generate, as FIG. 2B shows, for example, a skipped picture in which only a macroblock on the top left edge is an inter macroblock and the other macroblocks are skipped macroblocks. The inter macroblock indicates a bottom field located immediately preceding the skipped picture in the coding order as the picture to be referred to (reference picture) and has information indicating that motion compensation should be performed by 0 pixel horizontally and −0.5 pixel vertically with reference to the top field.

The image decoding apparatus, having obtained such a skipped picture as a top field that is the specific picture, can decode the skipped picture into a picture more approximate to the top field before the coding by performing motion compensation by −0.5 pixel vertically with reference to a bottom field located immediately preceding the skipped picture in every macroblock.

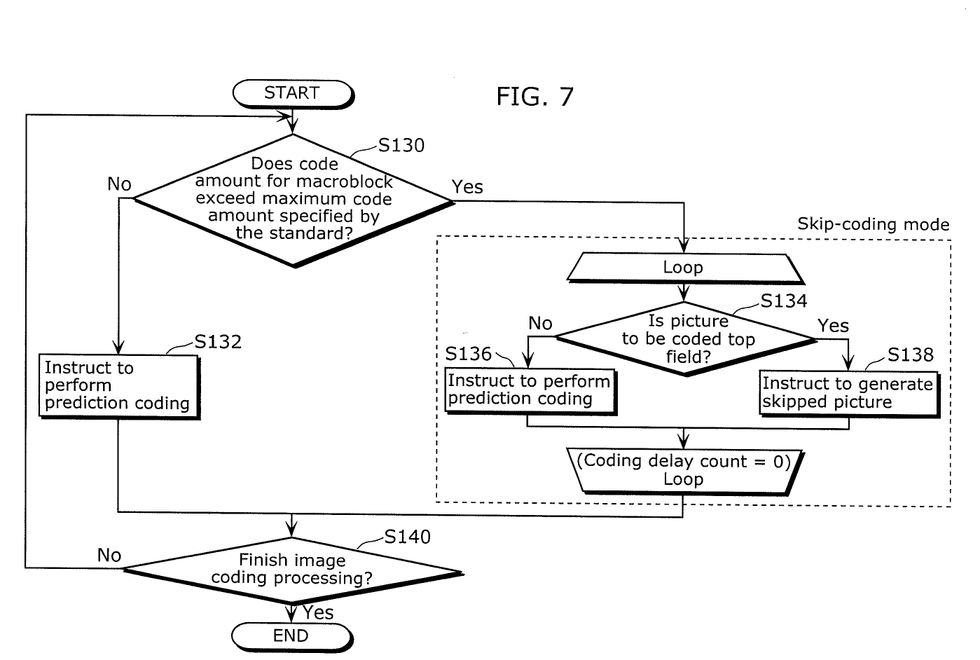

FIG. 7 is a flowchart showing the operation of the coding control unit 103 according to the present modification.

The coding control unit 103 determines whether or not entropy coding by the entropy coding unit 102 has generated over 3200 bits per macroblock, that is, determines whether or not a prediction-coded picture violating the standard has been generated (Step S130).

Here, upon determining that the standard violation has not occurred (No in Step S130), the coding control unit 103 continues the prediction-coding mode (Step S132).

On the other hand, upon determining that the standard violation has occurred (Yes in Step S130), the coding control unit 103 further determines whether or not the picture to be coded is a top field (Step S134). Then, upon determining that the input picture is not a top field, that is, upon determining that the input picture is a bottom field (No in Step S134), the coding control unit 103 instructs the image coding unit 101 to perform prediction coding on the picture to be coded while controlling the switch 103a so that the image coding unit 101 is connected to the entropy coding unit 102 (Step S136).

In addition, when the input picture is determined as a top field in Step S134 (Yes in Step S134), the coding control unit 103 instructs the skipped picture generation unit 104 to generate a skipped picture for the picture to be coded while controlling the switch 103a so that the skipped picture generation unit 104 is connected to the entropy coding unit 102 (Step S138).

Then, the coding control unit 103 continues the processing of steps from S134 to S138, that is, the processing by the skip-coding mode on the input pictures succeeding the violating input picture as the pictures to be coded until the coding delay count becomes 0.

In addition, the coding control unit 103 determines whether or not to finish the image coding processing (Step S140); all the processing operations are finished when it is determined that the processing should be finished (Yes in Step S140), whereas the operations starting from Step S130 are repeatedly performed when it is determined that the processing should not be finished (No in Step S140).

(Modification 2)

The coding control unit 103 according to the present modification uses a B-picture as the specific picture.

In addition, as FIG. 2A shows, for example, the skipped picture generation unit 104 according to the present modification generates a skipped picture made up of macroblocks that are all skipped macroblocks.

The image decoding apparatus, having obtained such a skipped picture as a B-picture that is the specific picture, refers to an I-picture or a P-picture located immediately preceding the B-picture in the coding order and decodes the skipped picture into a B-picture having the same picture as the I-picture or the P-picture. As a result, the decoded skipped picture has an image approximate to the B-picture before the coding.

In addition, the skipped picture generation unit 104 according to the present modification may also generate, as FIG. 2B shows, for example, a skipped picture in which only a macroblock on the top left edge is an inter macroblock and the other macroblocks are skipped macroblocks. The inter macroblock indicates an I-picture or a P-picture located immediately preceding the skipped picture in the coding order as the picture to be referred to (reference picture) and has information indicating that motion compensation should be performed by 0 pixel horizontally and ±0.5 pixel vertically with reference to the I-picture or the P-picture.

An image decoding apparatus, having obtained such a skipped picture as a B-picture that is the specific picture, can decode the skipped picture into a picture more approximate to the B-picture before the coding by performing motion compensation by ±0.5 pixel vertically with reference to the I-picture or P-picture located immediately preceding the skipped picture in every macroblock.

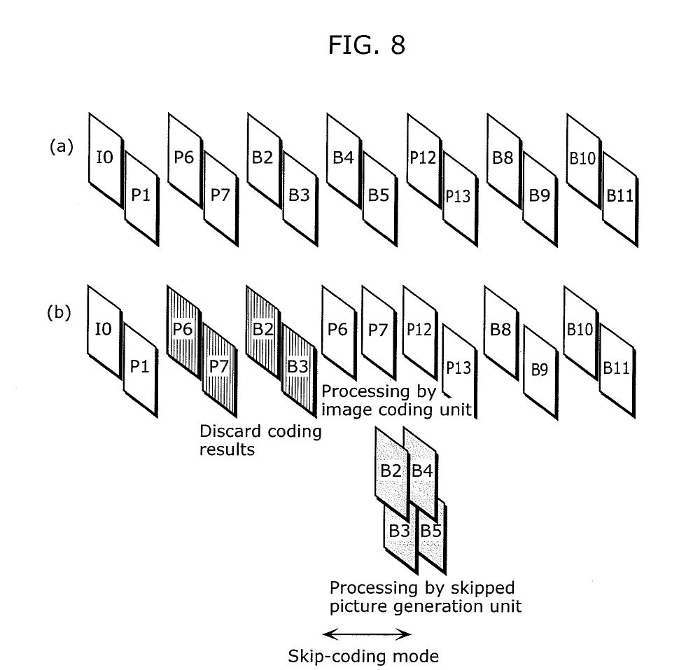

FIG. 8 is an explanatory diagram for describing the operation of the image coding apparatus 100 according to the present modification.

When the standard violation does not occur, as with the embodiment described above, the image coding apparatus 100 according to the present modification performs prediction coding and entropy coding, as FIG. 8(a) shows, on each input picture stored in the input image data memory 201 of the image coding unit 101 in an order staring from picture I0, to picture P1, to picture P6, to picture P7, . . . .

On the other hand, the image coding apparatus 100 performs the processing by the skip-coding mode, as FIG. 8(b) shows, when the standard violation occurs. For example, the image coding apparatus 100 determines that entropy coding (arithmetic coding) performed on a macroblock of picture P6 has resulted in the generation of over 3200 bits for the macroblock. At this time, as a result of the prediction coding and binarization performed on pictures P6, P7, B2, and B3, the image coding apparatus 100 discards all the binary data already stored in the binarized data buffer 302 and performs the processing by the skip-coding mode.

That is, the image coding apparatus 100 implements the processing by the skip-coding mode on picture 6 that is a violating input picture and each of the input pictures succeeding the picture P6 in the coding order until the coding delay count becomes 0.

Specifically, since picture P6 is not a B-picture that is the specific picture, the coding control unit 103 of the image coding apparatus 100 causes the image coding unit 101 to perform a second prediction coding on the picture P6, and causes the entropy coding unit 102 to perform entropy coding on the result. Then, since the subsequent picture P7 is not a B-picture that is the specific picture, the coding control unit 103 causes the image coding unit 101 to perform a second prediction coding on the picture P7, and causes the entropy coding unit 102 to perform entropy coding on the result.

Furthermore, since the subsequent picture B2 is a B-picture that is the specific picture, the coding control unit 103 causes the skipped picture generation unit 104 to generate a skipped picture for the picture B2, and causes the entropy coding unit 102 to perform entropy coding on the result. In the same manner as described above, since pictures B3, B4, and B5 are B-pictures, the coding control unit 103 causes the skipped picture generation unit 104 to generate skipped pictures for the input pictures, and causes the entropy coding unit 102 to perform entropy coding on the result.

Upon completion of the processing on the picture B5, the coding delay count becomes 0, and thereby the coding control unit 103 sets the coding mode by switching from the skip-coding mode to the prediction-coding mode. As a result, prediction coding is performed on every one of the pictures starting from picture P12 regardless of whether or not the pictures are B-pictures.

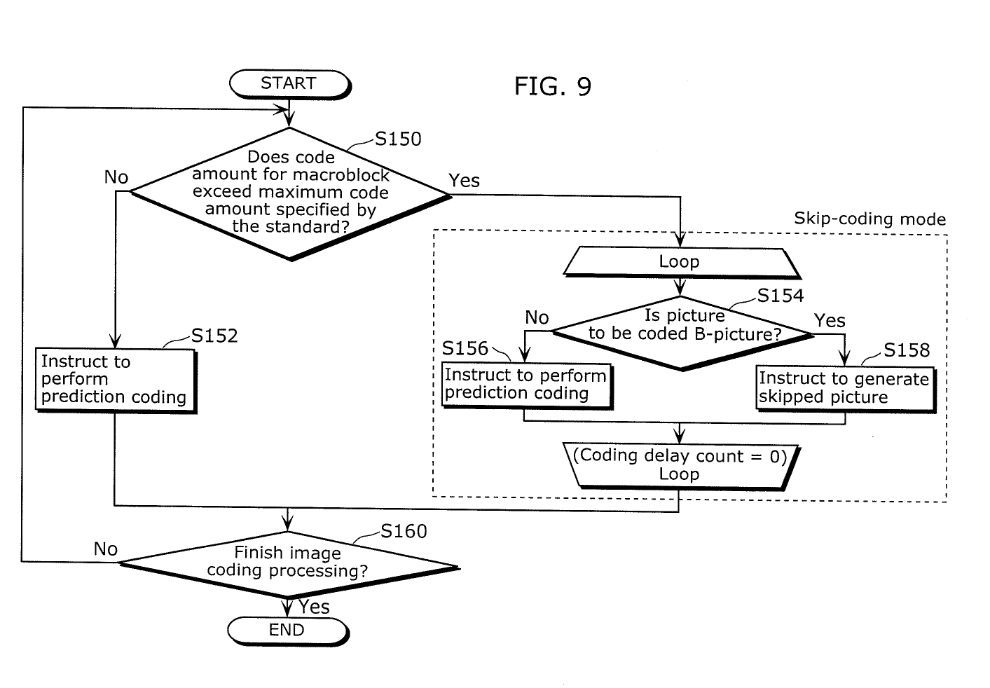

FIG. 9 is a flowchart showing the operation of the coding control unit 103 according to the present modification.

The coding control unit 103 determines whether or not entropy coding by the entropy coding unit 102 has generated over 3200 bits per macroblock, that is, determines whether or not a prediction-coded picture violating the standard has been generated (Step S150).

Here, upon determining that the standard violation has not occurred (No in Step S150), the coding control unit 103 continues the prediction-coding mode (Step S152).

On the other hand, upon determining that the standard violation has occurred (Yes in Step S150), the coding control unit 103 further determines whether or not the picture to be coded is a B-picture (Step S154). Then, upon determining that the input picture is not a B-picture (No in Step S154), the coding control unit 103 instructs the image coding unit 101 to perform prediction coding on the picture to be coded while controlling the switch 103a so that the image coding unit 101 is connected to the entropy coding unit 102 (Step S156).

In addition, when the input picture is determined as a B-picture in Step S154 (Yes in Step S154), the coding control unit 103 instructs the skipped picture generation unit 104 to generate a skipped picture for the picture to be coded while controlling the switch 103a so that the skipped picture generation unit 104 is connected to the entropy coding unit 102 (Step S158).

Then, the coding control unit 103 continues the processing of steps from S154 to S158, that is, the processing by the skip-coding mode on the input pictures succeeding the violating input picture as the pictures to be coded until the coding delay count becomes 0.

In addition, the coding control unit 103 determines whether or not to finish the image coding processing (Step S160); all the processing operations are finished when it is determined that the processing should be finished (Yes in Step S160), whereas the operations starting from Step S150 are repeatedly performed when it is determined that the processing should not be finished (No in Step S160).

(Modification 3)

The coding control unit 103 according to the present modification uses the bottom field of a B-picture as the specific picture.

In addition, as FIG. 2A shows, for example, the skipped picture generation unit 104 according to the present modification generates a skipped picture made up of macroblocks that are all skipped macroblocks.

The image decoding apparatus, having obtained such a skipped picture as the bottom field of a B-picture that is the specific picture, refers to a top field located immediately preceding the B-picture in the coding order and decodes the skipped picture into the bottom field of a B-picture having the same picture as the top field. As a result, the decoded skipped picture has an image approximate to the bottom field of the B-picture before the coding.

In addition, the skipped picture generation unit 104 according to the present modification may also generate, as FIG. 2B shows, for example, a skipped picture in which only a macroblock on the top left edge is an inter macroblock and the other macroblocks are skipped macroblocks. The inter macroblock indicates a top field located immediately preceding the skipped picture in the coding order as the picture to be referred to (reference picture) and has information indicating that motion compensation should be performed by 0 pixel horizontally and 0.5 pixel vertically with reference to the top field.

The image decoding apparatus, having obtained such a skipped picture as the bottom field of a B-picture that is the specific picture, can decode the skipped picture into a picture more approximate to the bottom field of the B-picture before the coding by performing motion compensation by 0.5 pixel vertically with reference to a top field located immediately preceding the skipped picture in every macroblock.

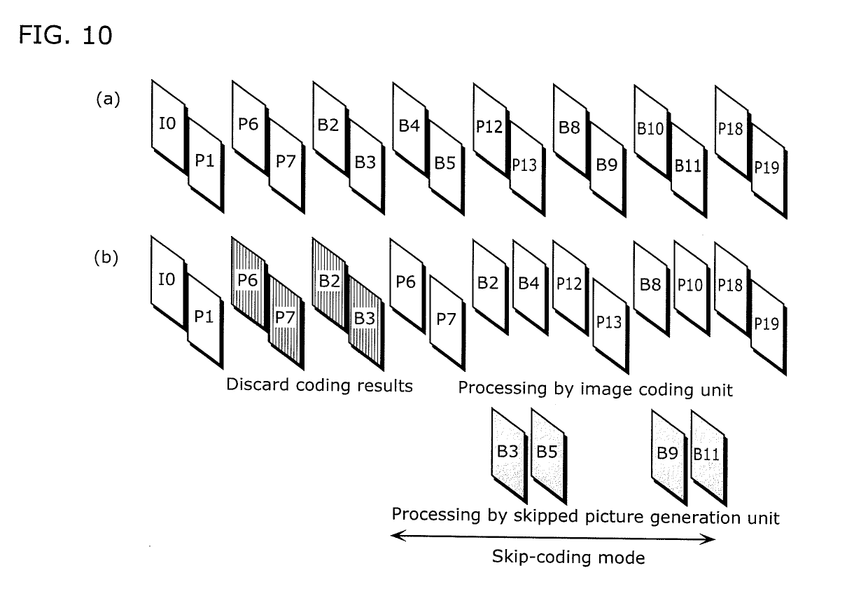

FIG. 10 is an explanatory diagram for describing an operation of the image coding apparatus 100 according to the present modification.

When the standard violation does not occur, the image coding apparatus 100 according to the present modification performs prediction coding and entropy coding, as FIG. 10(a) shows, on each input picture stored in the input image data memory 201 of the image coding unit 101 in an order staring from picture I0, to picture P1, to picture P6, to picture P7, . . . .

On the other hand, the image coding apparatus 100 performs the processing by the skip-coding mode, as FIG. 10(a) shows, when the standard violation occurs. For example, the image coding apparatus 100 determines that entropy coding (arithmetic coding) performed on a macroblock of picture P6 has resulted in the generation of over 3200 bits for the macroblock. At this time, as a result of the prediction coding and binarization performed on pictures P6, P7, B2, and B3, the image coding apparatus 100 discards all the binary data already stored in the binarized data buffer 302 and performs the processing by the skip-coding mode.

That is, the image coding apparatus 100 implements the processing by the skip-coding mode on picture 6 that is a violating input picture and each of the input pictures succeeding the picture P6 in the coding order until the coding delay count becomes 0.

Specifically, since picture P6 is not the bottom field of a B-picture that is the specific picture, the coding control unit 103 of the image coding apparatus 100 causes the image coding unit 101 to perform a second prediction coding on the picture P6, and causes the entropy coding unit 102 to perform entropy coding on the result. Then, since neither the subsequent picture P7 nor picture B2 that is subsequent to the picture P7 is the bottom field of a B-picture that is the specific picture, the coding control unit 103 causes the image coding unit 101 to perform a second prediction coding on the pictures P7 and B2, and causes the entropy coding unit 102 to perform entropy coding on the result.

Furthermore, since the subsequent picture B3 is the bottom field of a B-picture that is the specific picture, the coding control unit 103 causes the skipped picture generation unit 104 to generate a skipped picture for the picture B3, and causes the entropy coding unit 102 to perform entropy coding on the result.

Subsequently, in the same manner as described above, since pictures B4, P12, P13, B8, and B10 are not the bottom fields of B-pictures, the coding control unit 103 causes, in the same manner as described above, the image coding unit 101 to perform prediction coding on the input pictures, and causes the entropy coding unit 102 to perform entropy coding on the result. Then, in the same manner as described above, since pictures B5, B9, and B11 are the bottom fields of B-pictures, the coding control unit 103 causes the skipped picture generation unit 104 to generate skipped pictures for the input pictures, and causes the entropy coding unit 102 to perform entropy coding on the result.

Upon completion of the processing on picture B11, the coding delay count becomes 0, and thereby the coding control unit 103 sets the coding mode by switching from the skip-coding mode to the prediction-coding mode. As a result, prediction coding is performed on every one of the pictures starting from picture B18 regardless of whether or not the pictures are the bottom fields of B-pictures.

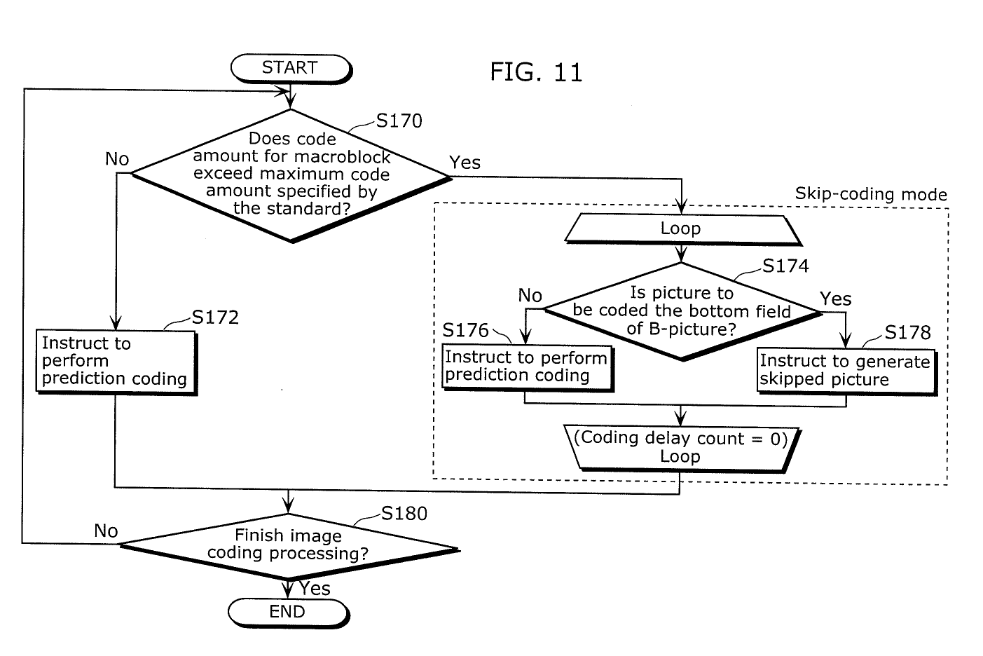

FIG. 11 is a flowchart showing the operation of the coding control unit 103 according to the present modification.

The coding control unit 103 determines whether or not entropy coding by the entropy coding unit 102 has generated over 3200 bits per macroblock, that is, determines whether or not a prediction-coded picture violating the standard has been generated (Step S170).

Here, upon determining that the standard violation has not occurred (No in Step S170), the coding control unit 103 continues the prediction-coding mode (Step S172).

On the other hand, upon determining that the standard violation has occurred (Yes in step S170), the coding control unit 103 further determines whether or not the picture to be coded is the bottom field of a B-picture (Step S174). Then, upon determining that the input picture is not the bottom field of a B-picture (No in Step S174), the coding control unit 103 instructs the image coding unit 101 to perform prediction coding on the picture to be coded while controlling the switch 103a so that the image coding unit 101 is connected to the entropy coding unit 102 (Step S176).

In addition, upon determining that the input picture is the bottom field of a B-picture in Step S174 (Yes in Step S174), the coding control unit 103 instructs the skipped picture generation unit 104 to generate a skipped picture for the picture to be coded while controlling the switch 103a so that the skipped picture generation unit 104 is connected to the entropy coding unit 102 (Step S178).

Then, the coding control unit 103 continues the processing of steps from S174 to S188, that is, the processing by the skip-coding mode on the input pictures succeeding the violating input picture as the pictures to be coded until the coding delay count becomes 0.

In addition, the coding control unit 103 determines whether or not to finish the image coding processing (Step S180); all the processing operations are finished when it is determined that the processing should be finished (Yes in Step S180), whereas the operations staring from Step S170 are repeatedly performed when it is determined that the processing should not be finished (No in step S170).

(Modification 4)

The coding control unit 103 according to the present modification uses the top field of a B-picture as the specific picture.

In addition, as FIG. 2A shows, for example, the skipped picture generation unit 104 according to the present modification generates a skipped picture made up of macroblocks that are all skipped macroblocks.

The image decoding apparatus, having obtained such a skipped picture as the top field of a B-picture that is the specific picture, refers to a bottom field located immediately preceding the top field of the B-picture in the coding order and decodes the skipped picture into the top field of a B-picture having the same picture as the bottom field. As a result, the decoded skipped picture has an image approximate to the top field of the B-picture before the coding.

In addition, the skipped picture generation unit 104 according to the present modification may also generate, as FIG. 2B shows, for example, a skipped picture in which only a macroblock on the top left edge is an inter macroblock and the other macroblocks are skipped macroblocks. The inter macroblock indicates a bottom field located immediately preceding the skipped picture in the coding order as the picture to be referred to (reference picture) and has information indicating that motion compensation should be performed by 0 pixel horizontally and −0.5 pixel vertically with reference to the bottom field.

An image decoding apparatus, having obtained such a skipped picture as the top field of a B-picture that is the specific picture, can decode the skipped picture into a picture more approximate to the top field of the B-picture before the coding by performing motion compensation by −0.5 pixel vertically with reference to a bottom field located immediately preceding the skipped picture in every macroblock.

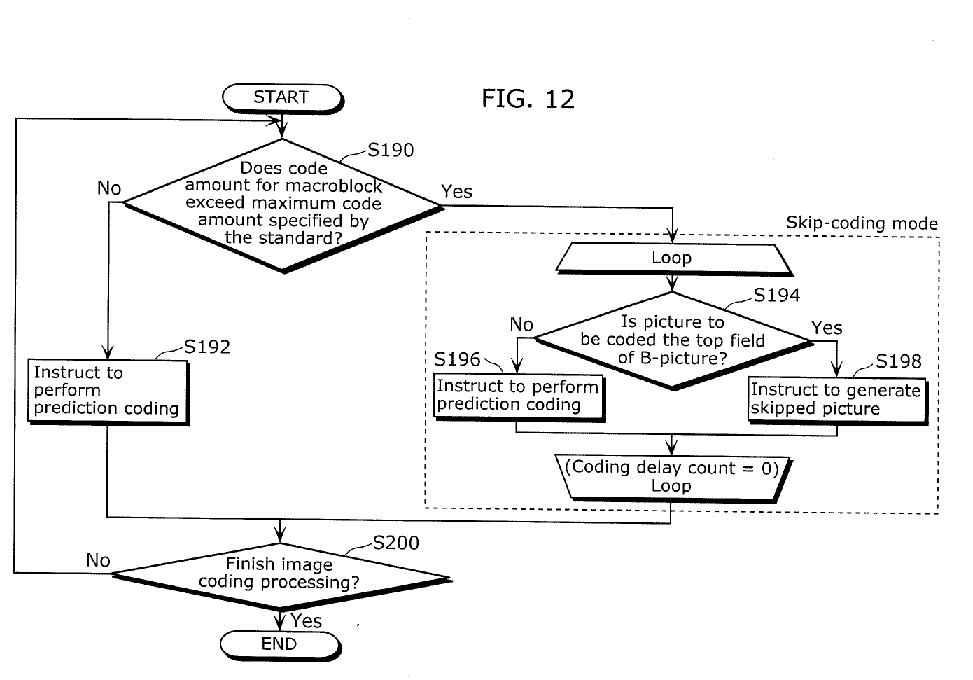

FIG. 12 is a flowchart showing the operation of the coding control unit 103 according to the present modification.

The coding control unit 103 determines whether or not entropy coding by the entropy coding unit 102 has generated over 3200 bits per macroblock, that is, determines whether or not a prediction-coded picture violating the standard has been generated (Step S190).

Here, upon determining that the standard violation has not occurred (No in Step S190), the coding control unit 103 continues the prediction-coding mode (Step S192).

On the other hand, upon determining that the standard violation has occurred (Yes in Step S190), the coding control unit 103 further determines whether or not the picture to be coded is the top field of a B-picture (Step S194). Then, upon determining that the input picture is not the top field of a B-picture (No in Step S194), the coding control unit 103 instructs the image coding unit 101 to perform prediction coding on the picture to be coded while controlling the switch 103a so that the image coding unit 101 is connected to the entropy coding unit 102 (Step S196).

In addition, upon determining that the input picture is the top field of a B-picture in Step S194 (Yes in Step S194), the coding control unit 103 instructs the skipped picture generation unit 104 to generate a skipped picture for the picture to be coded while controlling the switch 103a so that the skipped picture generation unit 104 is connected to the entropy coding unit 102 (Step S198).

Then, the coding control unit 103 continues the processing of steps starting from S194 to S198, that is, the processing by the skip-coding mode on the input pictures succeeding the violating input picture as the pictures to be coded until the coding delay count becomes 0.

In addition, the coding control unit 103 determines whether or not to finish the image coding processing (Step S200); all the processing operations are finished when it is determined that the processing should be finished (Yes in Step S200), whereas the operations staring from Step S190 are repeatedly performed when it is determined that the processing should not be finished (No in step S200).

Thus far, the image coding apparatus and the image coding method of the present invention have been described with reference to an embodiment and modifications thereof, but the present invention is not limited to these.

For example, in the above embodiment and the modifications thereof, a larger quantization step value is set for performing a second prediction coding on the violating input picture in order to prevent the recurrence of the standard violation; however, the violating input picture may also be converted into a prediction-coded picture. In other words, the macroblock violating the standard may be converted into I_PCM so as to be coded. In this case, the recurrence of the standard violation can also be reliably prevented.

In addition, in the embodiment and the modifications thereof, the skip-coding mode is caused to continue until the coding delay count becomes 0, but the skip-coding mode may also be switched to the prediction-coding mode before the coding delay count becomes 0.

In addition, each function block in the block diagrams shown in FIGS. 1, 3, and 4 may be typically implemented as an LSI that is an integrated circuit. The LSI may be single-chipped or multiple-chipped. (For example, block functions except for the memory may be single-chipped.) Although assumed as the LSI here, the circuit is also referred to as: IC, system LSI, super LSI, and ultra LSI according to the difference in the degree of integration.

In addition, the technique of such integrating circuitization is not limited to the LSI but may also be implemented as a dedicated circuit or a general-purpose processor. After manufacturing an LSI, a Field Programmable Gate Array (FPGA) that allows programming or a reconfigurable processor that allows reconfiguration of connections and settings of circuit cells inside the LSI may be implemented.

Furthermore, upon appearance of any integrated circuit technology to replace the LSI as a result of the development of semiconductor technology or other derivative technologies, the integration of function blocks may naturally be performed using the technology. The adaptation of biotechnology or the like is one of the possibilities.

In addition, in each function block, only a data-storing unit may have a different configuration instead of being single-chipped.

### INDUSTRIAL APPLICABILITY

The image coding apparatus of the present invention can implement, for example, video coding in accordance with H.264 with smaller circuit size and reduced power consumption, and can be applied to, for example, video cameras, camera-equipped cellular phones, and so on in addition to personal computers, HDD recorders, and DVD recorders.

1. An image coding apparatus, comprising:
an image coding unit configured to generate a coded picture having a pixel value by sequentially coding a plurality of input pictures;
a skipped picture generation unit configured to generate a skipped picture not having a pixel value;
an entropy coding unit configured to perform entropy coding on the coded picture and the skipped picture; and
a coding control unit which includes a determination unit configured to determine whether or not the entropy coding by said entropy coding unit has generated a coded picture including a macroblock having a code amount exceeding a threshold value, and which is configured to cause said skipped picture generation unit to generate a skipped picture for a specific picture without causing said image coding unit to perform coding, the specific picture being one of pictures that are an input picture corresponding to the coded picture including the macroblock and respective input pictures succeeding the input picture in a coding order.

2. The image coding apparatus according to claim 1,
wherein said image coding unit is configured to perform coding using a quantization step value, and
said coding control unit is configured to cause said image coding unit to perform a second coding on the input picture using a quantization step value larger than the quantization step value that has been used in the coding previously performed, when the input picture corresponding to the coded picture including the macroblock is not the specific picture.

3. The image coding apparatus according to claim 1,
wherein said coding control unit is configured to cause said image coding unit to generate a new coded picture from the input picture, when the input picture corresponding to the coded picture including the macroblock is not the specific picture.

4. The image coding apparatus according to claim 1,
wherein said coding control unit uses a bottom field as the specific picture, from among the pictures that are the input picture corresponding to the coded picture including the macroblock and the respective input pictures succeeding the input picture in the coding order.

5. The image coding apparatus according to claim 4,
wherein said skipped picture generation unit is configured to generate the skipped picture in which a macroblock on a top-left edge indicates that motion compensation should be performed by 0 pixel horizontally and 0.5 pixel vertically with reference to a top field located immediately preceding the skipped picture in the coding order, and in which other macroblocks are skipped macroblocks.

6. The image coding apparatus according to claim 1,
wherein said coding control unit uses a top field as the specific picture, from among the pictures that are the input picture corresponding to the coded picture including the macroblock and the respective input pictures succeeding the input picture in the coding order.

7. The image coding apparatus according to claim 6,
wherein said skipped picture generation unit is configured to generate the skipped picture in which a macroblock on a top-left edge indicates that motion compensation should be performed by 0 pixel vertically and − (minus) 0.5 pixel horizontally with reference to a bottom field located immediately preceding the skipped picture in the coding order, and in which other macroblocks are skipped macroblocks.

8. The image coding apparatus according to claim 1,
wherein said coding control unit uses a B-picture as the specific picture, from among the pictures that are the input picture corresponding to the coded picture including the macroblock and the respective input pictures succeeding the input picture in the coding order.

9. The image coding apparatus according to claim 8,
wherein said skipped picture generation unit is configured to generate the skipped picture in which a macroblock on a top-left edge indicates that an I-picture or a P-picture located immediately preceding the skipped picture in the coding order should be referred to, and in which other macroblocks are skipped macroblocks.

10. The image coding apparatus according to claim 1,
wherein said coding control unit uses a bottom field of a B-picture as the specific picture, from among the pictures that are the input picture corresponding to the coded picture including the macroblock and the respective input pictures succeeding the input picture in the coding order.

11. The image coding apparatus according to claim 10,
wherein said skipped picture generation unit is configured to generate the skipped picture in which a macroblock on a top-left edge indicates that motion compensation should be performed by 0 pixel horizontally and 0.5 pixel vertically with reference to a top field located immediately preceding the skipped picture in the coding order, and in which other macroblocks are skipped macroblocks.

12. The image coding apparatus according to claim 1,
wherein said coding control unit uses a top field of a B-picture as the specific picture, from among the pictures that are the input picture corresponding to the coded picture including the macroblock and the respective input pictures succeeding the input picture in the coding order.

13. The image coding apparatus according to claim 12,
wherein said skipped picture generation unit is configured to generate the skipped picture in which a macroblock on a top-left edge indicates that motion compensation should be performed by 0 pixel horizontally and − (minus) 0.5 pixel vertically with reference to a bottom field located immediately preceding in the coding order, and in which other macroblocks are skipped macroblocks.

14. The image coding apparatus according to claim 1,
wherein said determination unit uses, as the threshold value, a maximum code amount per macroblock that is specified by AVC/H.264.

15. The image coding apparatus according to claim 1,
wherein said entropy coding unit is configured to perform the entropy coding in accordance with Context-based Adaptive Binary Arithmetic Coding (CABAC).

16. The image coding apparatus according to claim 1,
wherein said skipped picture generation unit is configured to generate the skipped picture in which all macroblocks are skipped macroblocks.

17. The image coding apparatus according to claim 1,
wherein said coding control unit is configured to cause said skipped picture generation unit to generate a skipped picture until a delay in processing is eliminated when the delay is caused by causing said image coding unit to perform a second coding on an input picture that is not the specific picture and has already been coded by said image coding unit, from among the pictures that are the input picture corresponding to the coding picture including the macroblock and the respective input pictures succeeding the input picture in the coding order.

18. An image coding method, comprising:
generating a coded picture having a pixel value by sequentially coding a plurality of input pictures;
generating a skipped picture not having a pixel value;
performing entropy coding on the coded picture and the skipped picture;
determining whether or not the entropy coding in said performing has generated a coded picture including a macroblock having a code amount exceeding a threshold value; and
causing a skipped picture to be generated in said generating a skipped picture for a specific picture, without performing coding in said generating a coded picture, the specific picture being one of pictures that are an input picture corresponding to the coded picture including the macroblock and respective input pictures succeeding the input picture in a coding order.

19. An integrated circuit, comprising:
an image coding unit configured to generate a coded picture having a pixel value by sequentially coding a plurality of input pictures;
a skipped picture generation unit configured to generate a skipped picture not having a pixel value;
an entropy coding unit configured to perform entropy coding on the coded picture and the skipped picture; and
a coding control unit which includes a determination unit configured to determine whether or not the entropy coding by said entropy coding unit has generated a coded picture including a macroblock having a code amount exceeding a threshold value, and which is configured to cause said skipped picture generation unit to generate a skipped picture for a specific picture without causing said image coding unit to perform coding, the specific picture being one of pictures that are an input picture corresponding to the coded picture including the macroblock and respective input pictures succeeding the input picture in a coding order.
